(19) United States
(12) Patent Application Publication
(10) Pub. No.: US 2008/0259191 A1
(43) Pub. Date: Oct. 23, 2008

(54) Image Input Apparatus that Resolves Color Difference

(76) Inventors: Kunihiro Imamura, Osaka (JP); Toshiya Fujii, Shiga (JP); Takumi Yamaguchi, Kyoto (JP); Takahiko Murata, Osaka (JP)

Correspondence Address: MCDERMOTT WILL & EMERY LLP, 600 13TH STREET, NW, WASHINGTON, DC, 20005-3096, US

(21) Appl. No.: 11/663,063

(22) PCT Filed: Sep. 13, 2005
(86) PCT No.: PCT/JP05/17232

§ 371 Date: Feb. 21, 2008

(30) Foreign Application Priority Data
Sep. 17, 2004 (JP) 2004-272097
Oct. 14, 2004 (JP) 2004-299900

(51) Int. Cl. H04N 3/14

(52) U.S. Cl. 348/294; 348/E03.016

(57) ABSTRACT

A microcomputer outputs correction data. A shading correction circuit performs a shading correction to a digital image signal using the correction data outputted from the microcomputer. A YC processing circuit generates a video signal from the digital image signal having undergone the shading correction, performs processing such as a gamma correction to the generated video signal, and outputs the video signal having undergone the processing such as the gamma correction.

### TECHNICAL FIELD

The present invention relates to an image input apparatus, and in particular relates to a technology for resolving color differences attributable to downsizing of the image input apparatus and to increase in reliability thereof.

### BACKGROUND ART

In recent years, there is an increased demand for small solid-state imaging apparatuses, for reasons such as widespread use of portable telephones equipped with digital cameras. A solid-state imaging apparatus uses a color filter for separating incident light into three primary colors. A conventional material of a color filter is an organic material such as pigment. However recently, an inorganic material has started to be in use too.

There is a type of the color filter made of an inorganic material that uses a multi-layer interference film (see Japanese Laid-open patent application No. H05-045514 for example). It is easy to downsize the color filter made of an inorganic material, compared to its counterpart that uses an organic material. Therefore vigorous efforts for technology development are being put with respect to the color filter made of an inorganic material for use in solid-state imaging apparatuses.

### DISCLOSURE OF THE INVENTION

However, there is a problem with use of an organic material. When attempting to downsize a camera that uses a solid-state imaging apparatus, it becomes necessary to shorten the distance between the solid-state imaging apparatus and an optical system, where the optical system forms an image onto the solid-state imaging apparatus using incident light from a subject. Accordingly, the incident angle of incident light upon the solid-state imaging apparatus becomes large.

Under this condition, if the solid-state imaging apparatus uses a color filter made of an inorganic material, color difference will occur in the circumferential parts of a resulting image. This is because of the fact that a color filter made of an inorganic material transmits light of different wavelength depending on the incident angles of the light, unlike a color filter that uses an organic material.

The present invention has been conceived in view of the above-stated problem, and has an object of providing an image input apparatus equipped with a color filter made of an inorganic material, which does not cause color differences in the circumferential parts of an image.

So as to achieve this object, an image input apparatus relating to the present invention has a solid-state imaging device for capturing an image of a subject, and a signal processing unit for processing an image signal that the solid-state imaging device outputs, where the solid-state imaging device includes: a plurality of filter units made of an inorganic material, each filter unit being operable to transmit a corresponding one of color components of light; and a plurality of light receiving units arranged two-dimensionally in a semiconductor substrate, each light receiving unit being operable to receive one of the color components of light transmitted through a corresponding one of the filter units, and the signal processing unit corrects the image signal in accordance with the color components and positions in the captured image.

With the stated structure, realized is an image input apparatus equipped with a color filter made of an inorganic material, which does not cause color differences in the circumferential parts of an image.

In the image input apparatus of the present invention, the filter units may have a multi-layer film structure.

With the stated structure, it becomes possible to downsize an image input apparatus.

In addition, it is preferable that each of the filter units includes: two λ/4 multi-layer films, each of which is made of a plurality of dielectric layers; and an insulation layer sandwiched between the λ/4 multi-layer films, the insulation layer having an optical thickness different from λ/4. It is even more preferable that the optical thickness of the insulation layer differs according to color components of light to be received by the corresponding light receiving units.

The image input apparatus of the present invention may have a structure in which each of the λ/4 multi-layer films is made of a high refractive-index material and a low refractive-index material, the insulation layer contains first portions made of the high refractive-index material and second portions made of the low refractive-index material, the first and second portions being arranged alternately in a direction along a main surface of the filter units, and the insulation layer transmits light of a wavelength that is in accordance with an area ratio between the first portions and the second portions in a plan view.

With the stated structure, it becomes possible to manufacture filter units only by a semiconductor process, which helps reduce the cost of manufacturing an image input apparatus.

The image input apparatus of the present invention may have a structure in which the solid-state imaging device includes a light shielding unit, the light shielding unit being operable to shield incident light and being positioned in an opposite side of the light receiving units with respect to the filter unit, and the light shielding unit is provided with openings in positions corresponding to the light receiving units respectively, in order for the incident light to pass through.

With the stated structure, light to be incident onto a light receiving unit is prevented from being incident onto other light receiving units.

The image input apparatus of the present invention may have a structure in which the signal processing unit divides the captured image into two or more areas, and corrects the image signal in accordance with the color components and the areas.

With the stated structure, attenuation of signal level that is different depending on color components and positions in an image is able to be corrected. Accordingly, it is possible to resolve color difference occurring at circumferential parts of the image.

The image input apparatus of the present invention may have a structure in which the signal processing unit divides the captured image into two or more areas by figures having shapes similar to each other but different in size from each other, the figures sharing a same center, and the signal processing unit corrects the image signal in accordance with the color components and the areas. In particular, where an optical lens forms a subject image to be captured by the solid-state imaging device, and a diaphragm restricts light to be incident upon the optical lens, if the figures are substantially similar in shape to an aperture of the diaphragm, it is particularly effective to enable an image input apparatus equipped with a diaphragm, to resolve color differences.

Here, the shape of the figures may be substantially circular. The incident angles of incident light upon the light receiving units are symmetrical with respect to the optical axis of an optical lens. Therefore, the degree of color difference is substantially the same within each of areas that is sandwiched between two concentric circles whose center coincides with the center of an image. On the contrary, the degree of color difference differs between these areas. In view of this, it is possible to resolve noticeable color difference occurring in the circumferential parts of the image, by correcting image signals differently for each of the areas.

Concretely, the signal processing unit may correct the image signal by multiplying a level of the image signal by a coefficient that is determined in accordance with the color components and the positions in the captured image. The signal processing unit may also correct the image signal by adding, to a level of the image signal, a constant that is determined in accordance with the color components and the positions in the captured image. The signal processing unit may further correct the image signal by adding, to a level of the image signal, a constant that is determined in accordance with the color components and the positions in the captured image, and by multiplying a result of the addition by a coefficient that is determined in accordance with the color components and the positions in the captured image.

In addition, the image input apparatus of the present invention may have a storage unit storing correction data, where the signal processing unit corrects the image signal using the correction data.

With the stated structure, color difference is corrected with enhanced speed.

Furthermore, the image input apparatus of the present invention may have a structure in which the signal processing unit replaces a level of the image signal with the correction data, in accordance with the color components and the positions in the captured image.

With the stated structure, color difference correction does not require arithmetic operations, thereby enabling even more speedup of the processing.

In the above structure, the storage unit may have a nonvolatile memory to store the correction data, or the storage unit may have a volatile memory to store the correction data.

In addition, the image input apparatus of the present invention may have an update unit operable to update the correction data stored in the storage unit.

With the stated structure, even when the manner of color difference changes ascribable to exchange of optical systems or the like, it is still possible to correct an image accurately by updating correction data.

Furthermore, the image input apparatus of the present invention may have a storage unit storing first correction data for correcting the image signal for a part of the positions, where the signal processing unit a) performs the correction for the part of the positions, by using the first correction data, and b) performs the correction for the other part of the positions, by using second correction data calculated from the first correction data.

With the stated structure, it is not necessary to keep in storage correction data for all the addresses relating to image signal, because the structure enables to generate correction data of other addresses from the correction data in storage. Accordingly, a storage capacity required to store correction data is reduced, which helps reduce the cost of manufacturing an image input apparatus.

For interpolating correction data of the other addresses using the correction data in storage, one piece of the second correction data may be calculated from two pieces of the first correction data using a linear function, or one piece of the second correction data may also be calculated from two pieces of the first correction data using a quadratic function. With the stated structures, it is possible to generate more appropriate correction data with ease.

The present invention also provides an image input apparatus having a solid-state imaging device for capturing an image of a subject, and a signal processing unit for processing an image signal that the solid-state imaging device outputs, where the solid-state imaging device includes: a plurality of filter units made of an inorganic material, each filter unit being operable to transmit a corresponding one of color components of light; and a plurality of light receiving units arranged two-dimensionally in a semiconductor substrate, each light receiving unit being operable to receive one of the color components of light transmitted through a corresponding one of the filter units, and the signal processing unit generates an image using image signals corresponding to coordinates that fall within a predetermined distance from a center of the captured image.

With the stated structure, the circumferential parts of the image, where color difference is noticeable, are cut away, and so the color difference at these parts is eliminated with enhanced speed.

In the above structure, the signal processing unit, prior to generating the image, may correct the image signals in accordance with the color components and the positions in the captured image.

In the image input apparatus of the present invention, the filter units may be made of a single-layer film that has optical thicknesses respectively substantially equal to ½ of wavelengths corresponding to color components of light to be transmitted. With the stated structure, too, the object of the present invention is achieved.

### BRIEF DESCRIPTION OF THE DRAWINGS

FIG. 1 is a block diagram showing a functional structure of an electronic still camera relating to the first embodiment of the present invention.

FIG. 2 is a block diagram showing an overall structure of an image sensor 103 relating to the first embodiment of the present invention.

FIG. 3 is a sectional view of a part of the structure of the image sensor 103 relating to the first embodiment of the present invention.

FIG. 4 is a block diagram showing a functional structure of a digital signal processing circuit 106 relating to the first embodiment of the present invention.

FIG. 5 is a block diagram showing a structure of a shading correction circuit 406 according to the first embodiment of the present invention.

FIG. 6 is a diagram showing an example of area division of a digital image relating to the first embodiment of the present invention.

FIG. 7 is a block diagram showing a functional structure of an electronic still camera relating to the second embodiment of the present invention.

FIGS. 8A and 8B are respectively a diagram showing a main structure of a diaphragm 700 relating to the second embodiment of the present invention. FIG. 8A illustrates a state in which the quantity of light is increased, and FIG. 8B illustrates a state in which the quantity of light is decreased.

FIG. 9 is a block diagram showing a functional structure of a shading correction circuit relating to the second embodiment of the present invention.

FIG. 10 is a diagram showing an example of area division of a digital image relating to the second embodiment of the present invention.

FIG. 11 is a block diagram showing a functional structure of a shading correction circuit relating to the third embodiment of the present invention.

FIG. 12 is a diagram showing area division of a digital image relating to the third embodiment of the present invention.

FIG. 13 is a block diagram showing a functional structure of a shading correction circuit relating to the fourth embodiment of the present invention.

FIG. 14 is a diagram showing a selection example of representative addresses in a digital image, which relates to a modification example of the fourth embodiment of the present invention.

FIG. 15 is a block diagram showing a functional structure of an electronic still camera relating to the fifth embodiment of the present invention.

FIG. 16 is a block diagram showing a functional structure of a digital signal processing circuit 1506 relating to the fifth embodiment of the present invention.

FIGS. 17A and 17B relate to graphs showing one example of how the shading characteristic of a digital image signal and correction data change for each position in a digital image.

FIG. 18 is a block diagram showing a functional structure of a digital signal processing circuit relating to the sixth embodiment of the present invention.

FIG. 19 is a diagram showing an example of a digital image that a digital signal processing circuit 18 processes, which relates to the sixth embodiment of the present invention.

FIG. 20 is a sectional diagram showing a structure of color filters relating to a modification example (1) of the present invention.

FIG. 21 is a sectional diagram showing a part of the structure of an image sensor relating to a modification example (2) of the present invention.

FIG. 22 is a sectional diagram showing a part of the structure of an image sensor relating to a modification example (4) of the present invention.

FIG. 23 is a graph showing transmission characteristics of color filters relating to a modification example (4) of the present invention.

### BEST MODE FOR CARRYING OUT THE INVENTION

The following describes embodiments of the image input apparatus relating to the present invention using an electronic still camera as an example, with reference to the drawings.

### <1> FIRST EMBODIMENT

As follows, an electronic still camera relating to the first embodiment of the present invention is described.

(1) Structure of Electronic Still Camera

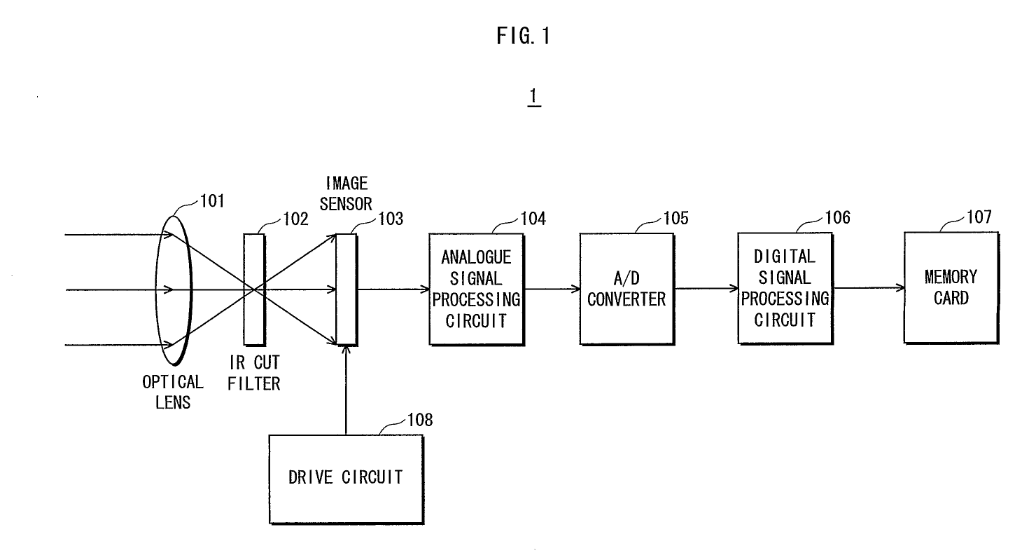

First, the structure of the electronic still camera relating to the present embodiment is described. FIG. 1 is a block diagram showing a functional structure of the electronic still camera relating to the present embodiment. As shown in FIG. 1, an electronic still camera 1 includes: an optical lens 101, an IR (infrared rays) cut filter 102, an image sensor 103, an analogue signal processing circuit 104, an A/D (analogue to digital) converter 105, a digital signal processing circuit 106, a memory card 107, and a drive circuit 108.

The optical lens 101 forms an image on the image sensor 103, using incident light from a subject. The IR cut filter 102 removes long wavelength components from the incident light by filtration, so that only components having passed through the IR cut filter 102 are irradiated onto the image sensor 103. The image sensor 103 is a so-called single plate CCD (charge coupled device) image sensor, which is provided with a single color filter for filtering incident light onto each of photoelectric transducers provided two-dimensionally. The image sensor 103 reads charges in accordance with driving signals received from the drive circuit 108, and outputs analogue image signals.

The analogue signal processing circuit 104 performs, onto the analogue image signals that the image sensor 103 has output, processing such as correlated double sampling and signal amplification. The A/D converter 105 converts signals output from the analogue signal processing circuit 104 into digital image signals. The digital signal processing circuit 106 corrects color differences of the digital image signals, and then generates digital video signals. The memory card 107 is for storing therein the digital video signals.

(2) Structure of Image Sensor 103

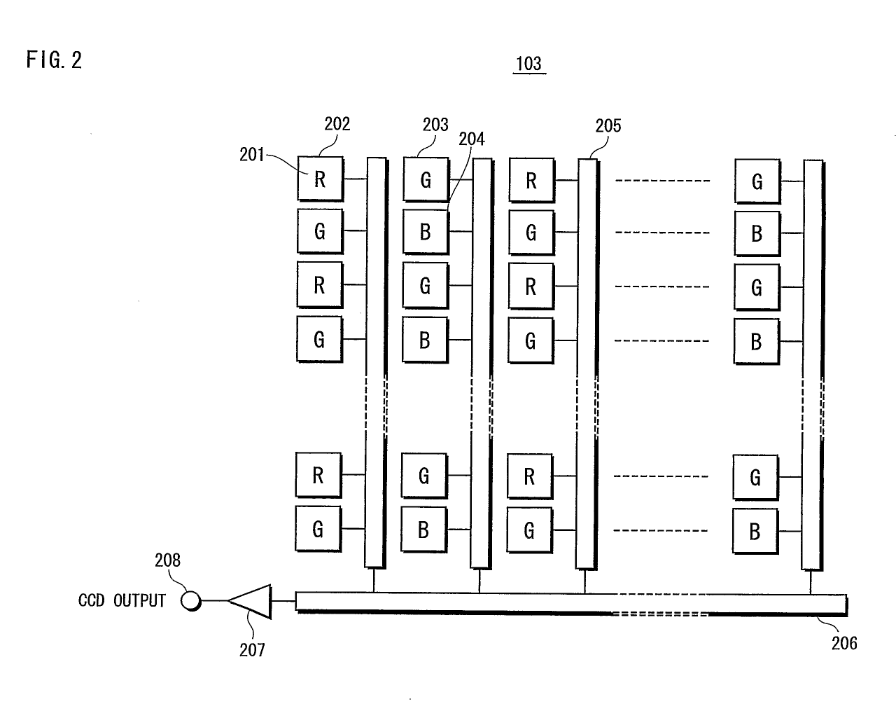

Next, the structure of the image sensor 103 is described. FIG. 2 is a block diagram showing the overall structure of the image sensor 103. As shown in FIG. 2, the image sensor 103 includes photoelectric transducers 201, color filters 202-204, a vertical transfer CCD 205, a horizontal transfer CCD 206, an amplifying circuit 207, and an output terminal 208.

The photoelectric transducers 201 are arranged two-dimensionally. On the photoelectric transducers 201, an color filter 202 for the red color, a color filter 203 for the green color, and a color filter 204 for the blue color are provided in a Bayer pattern. Only a particular color component of light incident upon a color filter reaches a corresponding photoelectric transducer 201, to be converted into a charge signal.

In accordance with a driving pulse from the drive circuit 108, the vertical transfer CCD 205 transfers charge signals of the photoelectric transducers 201 to the horizontal transfer CCD 206. In turn, the horizontal transfer CCD 206 transfers the charge signals received from the vertical transfer CCD 205, to the amplifying circuit 207, in accordance with a driving pulse from the drive circuit 108. The amplifying circuit 207 converts the charge signals into voltage signals, and outputs the voltage signals through the output terminal 208.

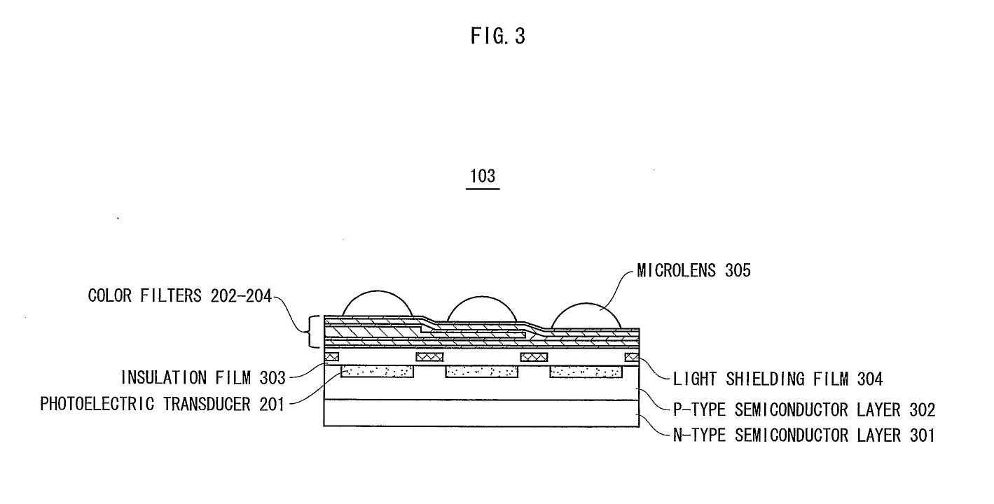

FIG. 3 is a sectional view of a part of the structure of the image sensor 103. As shown in FIG. 3, the image sensor 103 includes an n-type semiconductor layer 301, a p-type semiconductor layer 302, photoelectric transducers 201, an insulation film 303, light shielding films 304, color filters 202-204, and microlenses 305.

The p-type semiconductor layer 302 is formed on the n-type semiconductor layer 301. The photoelectric transducers 201 are formed by ion-implanting an n-type impurity to the p-type semiconductor layer 302. The insulation film 303 is formed on the p-type semiconductor layer 302 and on the photoelectric transducers 201. The insulation film 303 has a characteristic of transmitting light. In the insulation film 302, the light shielding films 304 are formed. The light shielding films 304 function to make sure that only light transmitted through a color filter is incident to a corresponding photoelectric transducer 201, and to shield the particular photoelectric transducer 201 against light transmitted through the other color filters. The color filters 202-204 are formed on the insulation film 303.

The color filters 202-204, respectively, have such a structure that two λ/4 dielectric multi-layer films sandwich a spacer layer having an optical thickness different from λ/4, where each λ/4 dielectric multi-layer film is made by alternately stacking two kinds of layers respectively made of titanium oxide (TiO₂) and silicon oxide (SiO₂) (both being inorganic materials). Note that the optical thickness of the spacer layer differs in each of regions corresponding to the color filters 202-204, in accordance with the wavelength of light that each color filter 202-204 intends to transmit. Microlenses are provided on the color filters 202-204, in positions corresponding to the photoelectric transducers 201 respectively. The microlenses focus incident light on the photoelectric transducers 201.

(3) Digital Signal Processing Circuit 106

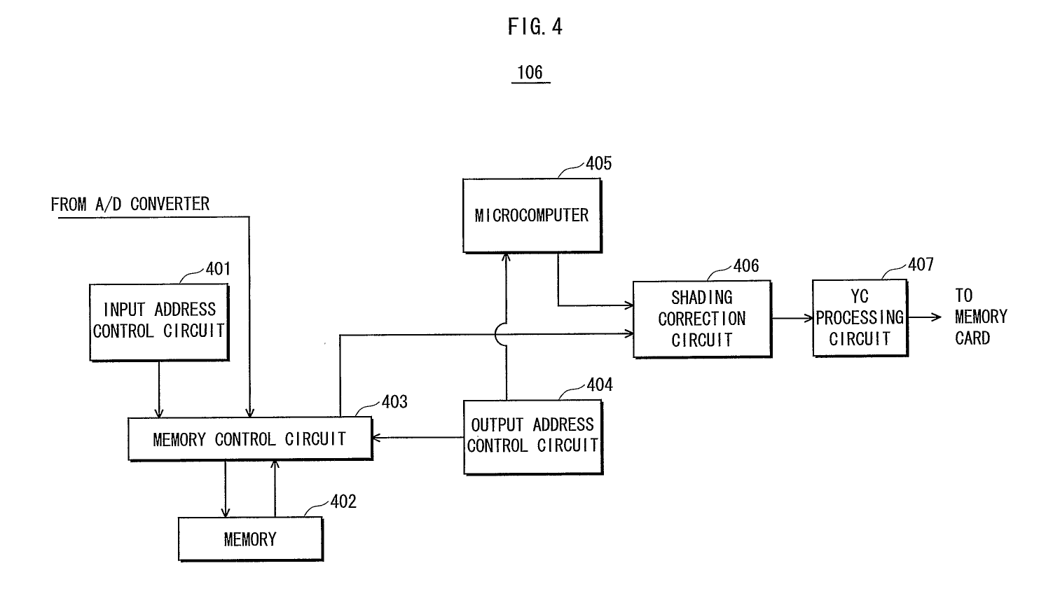

Next, the digital signal processing circuit 106 is described. FIG. 4 is a block diagram showing a functional structure of the digital signal processing circuit 106.

As shown in FIG. 4, the digital signal processing circuit 106 includes: an input address control circuit 401, a memory 402, a memory control circuit 403, an output address control circuit 404, a microcomputer 405, a shading correction circuit 406, and a YC processing circuit 407.

The input address control circuit 401 controls an address of a digital image signal. The memory 402 is for storing therein a digital image signal. The output address control circuit 404 controls an address used for reading a digital image signal stored in the memory 402. In addition, the output address control circuit 404 instructs the microcomputer 405 to output correction data for correcting a digital image signal. The memory control circuit 403 generates a control signal for controlling read/write of data with respect to the memory 402, in accordance with control signals from both of the input address control circuit 401 and the output address control circuit 404.

The microcomputer 405 outputs correction data, thereby making the shading correction circuit 406 correct a digital image signal. The shading correction circuit 406 performs shading correction to a digital image signal using correction data output from the microcomputer 405. The YC processing circuit 407 generates a video signal from the digital image signal having undergone shading correction, and performs to the generated video signal gamma correction or the like, and outputs the resulting video signal.

The gamma correction is non-linear processing. Therefore, it is preferable to perform a shading correction before the YC processing.

(4) Shading Correction Circuit 406

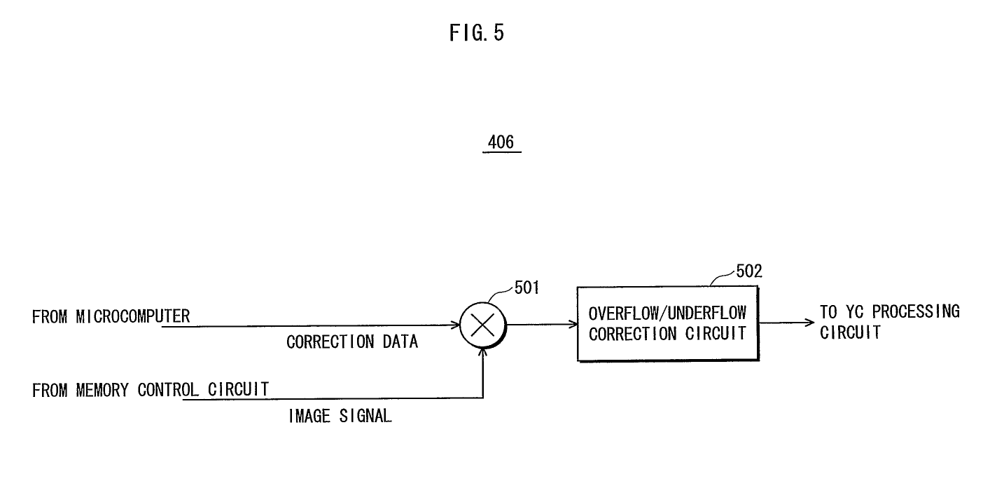

Next, the shading correction circuit 406 is described. FIG. 5 is a block diagram showing a structure of the shading correction circuit 406.

As shown in FIG. 5, the shading correction circuit 406 includes a multiplier 501 and an overflow/underflow correction circuit 502. The multiplier 501 multiplies a digital image signal from the memory control circuit 403 by correction data from the microcomputer 405, and outputs thus obtained multiplication result. The overflow/underflow correction circuit 502 performs a clipping operation to the multiplication result when it has detected any overflow or underflow regarding the multiplication result so that the multiplication result will be in a predetermined bit range.

(5) Correction Data

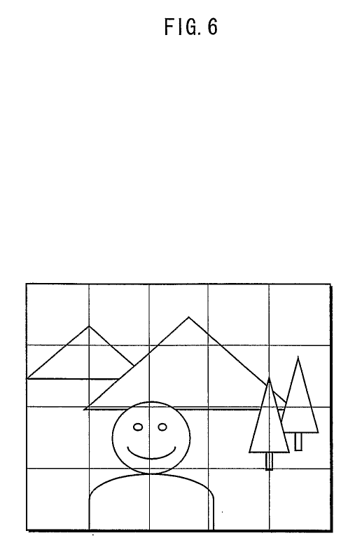

The microcomputer 405 outputs different correction data for each position in a captured digital image, to which digital image signals correspond. In the present embodiment, the microcomputer 405 divides the digital image into a plurality of areas, and outputs correction data having a different value for each area. This means that if two digital image signals correspond to a same area, the same correction data is output to the area. FIG. 6 is a diagram showing an example of area division of a digital image. In FIG. 6, the digital image is divided into 20 areas.

By doing so, arbitrary shading correction becomes possible for each address of digital image signal. Accordingly, color difference unique to each area of a digital image will be accurately corrected. In addition, use of the multiplier 501 enables proper shading correction even in case where a different gain fluctuation is caused for each address.

### <2> SECOND EMBODIMENT

Next, an electronic still camera relating to the second embodiment of the present invention is described. The electronic still camera relating to the present embodiment is substantially the same in structure as the electronic still camera relating to the first embodiment, except that the electronic still camera relating to the present embodiment is equipped with a diaphragm. The following description mainly focuses on this difference.

(1) Structure of Electronic Still Camera

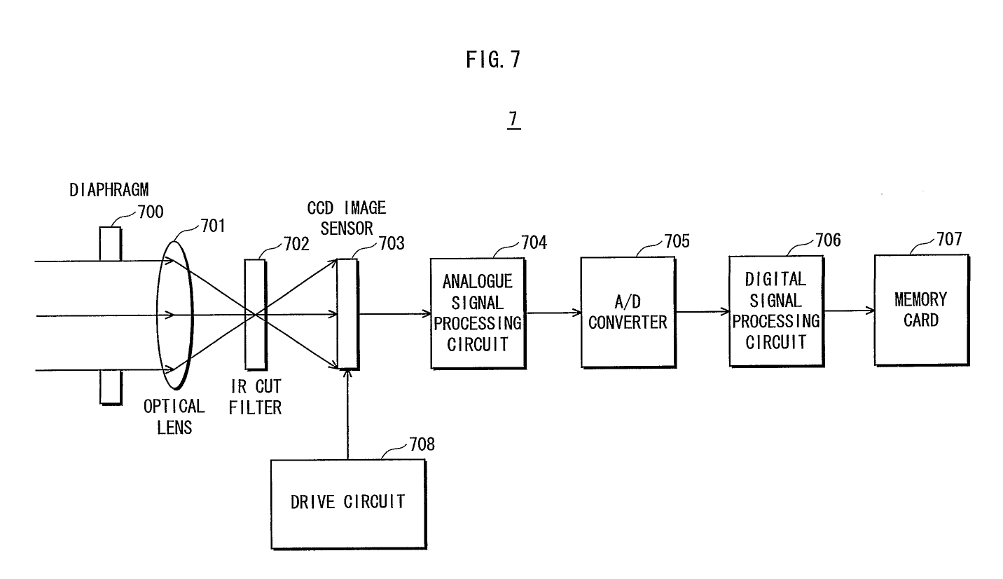

FIG. 7 is a block diagram showing a functional structure of the electronic still camera relating to the present embodiment. As shown in FIG. 7, the electronic still camera 7 includes a diaphragm 700, an optical lens 701, an IR cut filter 702, an image sensor 703, an analogue signal processing circuit 704, an A/D converter 705, a digital signal processing circuit 706, a memory card 707, and a drive circuit 708. The diaphragm 700 adjusts a quantity of light to be incident upon the optical lens 701.

(2) Structure of Diaphragm 700

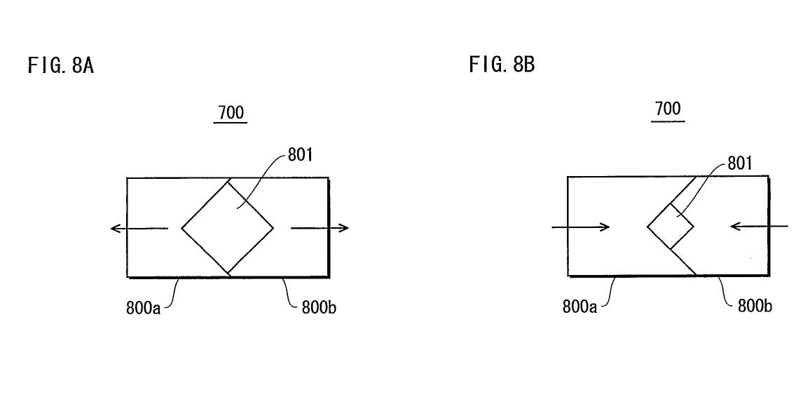

FIGS. 8A and 8B respectively show a main structure of the diaphragm 700. FIG. 8A illustrates a state in which the quantity of light is increased, and FIG. 8B illustrates a state in which the quantity of light is decreased. The diaphragm 700 is equipped with two blades 800a and 800b. As shown in FIG. 8A, when the blades 800a and 800b are set to be apart from each other, the incident light upon the optical lens 701 will increase in quantity, thereby increasing the quantity of light to be incident upon the image sensor 703. Conversely, when the blades 800a and 800b are set to be close to each other, as shown in FIG. 8B, the quantity of incident light upon the image sensor 703 will decrease. In this way, the diaphragm 700 adjusts the quantity of incident light upon the image sensor 703.

(3) Structure of Shading Correction Circuit

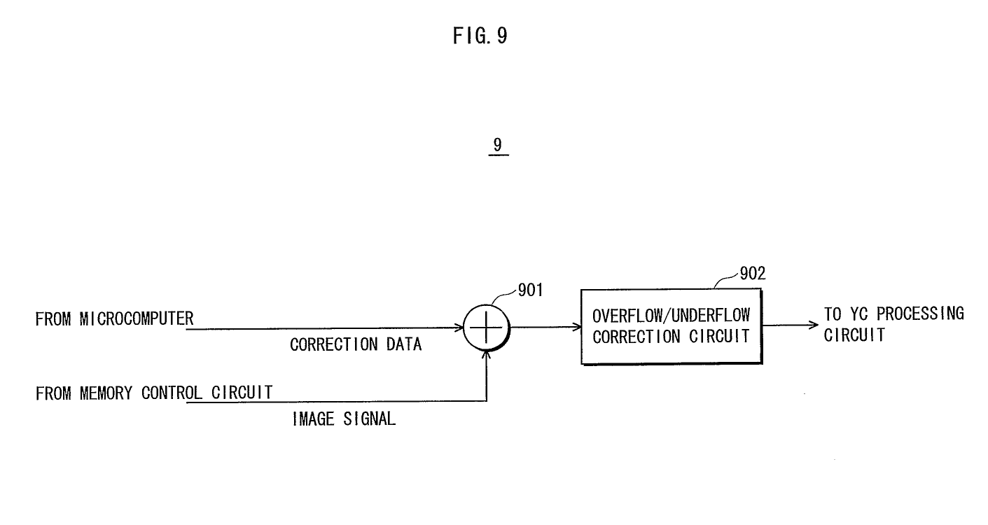

The digital signal processing circuit 706 has substantially the same structure as that of the digital signal processing circuit 106 relating to the first embodiment, however is different in the structure of the shading correction circuit. FIG. 9 is a block diagram showing a functional structure of the shading correction circuit relating to the present embodiment.

As shown in FIG. 9, the shading correction circuit 9 includes an adder 901 and an overflow/underflow correction circuit 902. The adder 901 adds correction data from the microcomputer and a digital image signal from the memory control circuit, and outputs thus obtained addition result. The overflow/underflow correction circuit 902 performs a clipping operation to the addition result when it has detected any overflow or underflow regarding the addition result so that the addition result will be in a predetermined bit range.

By doing so, it is possible to correct shading occurring as an offset fluctuation at a different level depending on each address of image signal.

(4) Correction Data

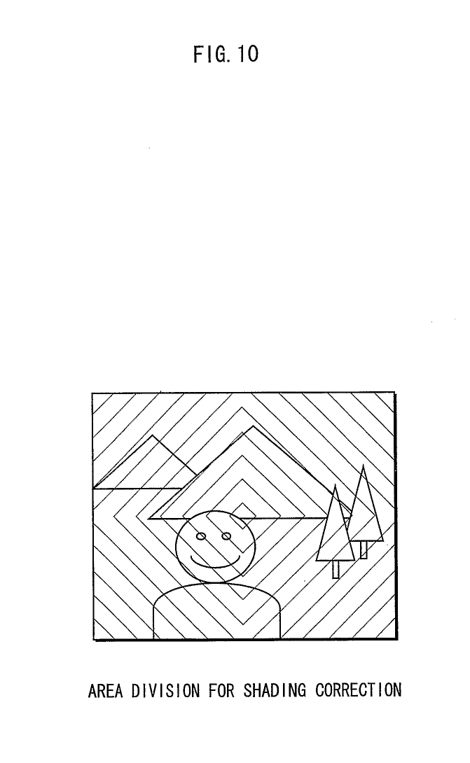

In the present embodiment, a digital image is divided into areas each having a rhombus shape whose center coincides with a center of the digital image. In other words, area division in the present embodiment is performed so that each resulting area has a shape similar to the shape of the opening of the diaphragm 700. FIG. 10 is a diagram showing an example of area division of a digital image relating to the present embodiment. In FIG. 10, the digital image is divided into areas by rhombus figures, where each area is associated with a corresponding one of 12 kinds of correction data, in accordance with distances from the center of the digital image.

If incident rays of light to the image sensor have a same distance with the center of the digital image both in horizontal and vertical directions, then the incident rays of light will have substantially the same incident angle.

In the first embodiment, the digital image is divided in a lattice pattern elongating in lengthwise and crosswise directions. This division does not match the incident-angle characteristics of the incident rays of light, and so it becomes necessary to increase the number of areas to perform an effective shading correction. On the other hand, in the present embodiment, the digital image is divided into areas respectively having a rhombus shape symmetrical both in the horizontal and vertical directions, for assigning correction data to them. Accordingly, it is possible to perform a shading correction that matches the incident-angle characteristics of the incident rays of light, with a smaller number of areas. This decreases the number of correction data that must be memorized, which is instrumental in simplifying the operations and downsizing the circuit dimension of the shading correction circuit.

### <3> THIRD EMBODIMENT

Next, the third embodiment of the present invention is described. An electronic still camera relating to the present embodiment is substantially the same in structure as the electronic still camera relating to the first embodiment, except for the operations performed by the shading correction circuit. The following description mainly focuses on this difference.

(1) Structure of Shading Correction Circuit

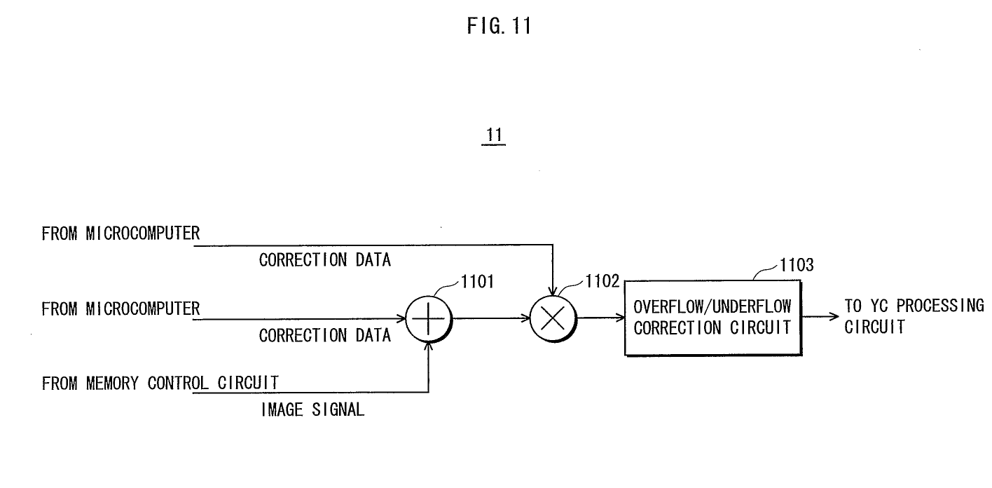

FIG. 11 is a block diagram showing a functional structure of the shading correction circuit relating to the present embodiment. As shown in FIG. 11, the shading correction circuit 11 includes an adder 1101, a multiplier 1102, and an overflow/underflow correction circuit 1103.

The shading correction circuit 11 receives two types of correction data. The adder 1101 adds the first-type correction data and a digital image signal, and outputs the addition result. The multiplier 1102 multiplies the addition result by second-type correction data, and outputs the multiplication result. The overflow/underflow correction circuit 1103 performs a clipping operation to the multiplication result.

By doing so, it is not only possible to correct shading occurring as an offset fluctuation at a different level for each address of image signal, but also to correct shading occurring as a gain fluctuation at a different level for each address of image signal.

(2) Correction Data

As stated above, the present embodiment uses two types of correction data for performing a shading correction. In the present embodiment, the digital image is divided into a plurality of areas, and a different value of correction data is assigned to each one of the areas, just as in the other embodiments.

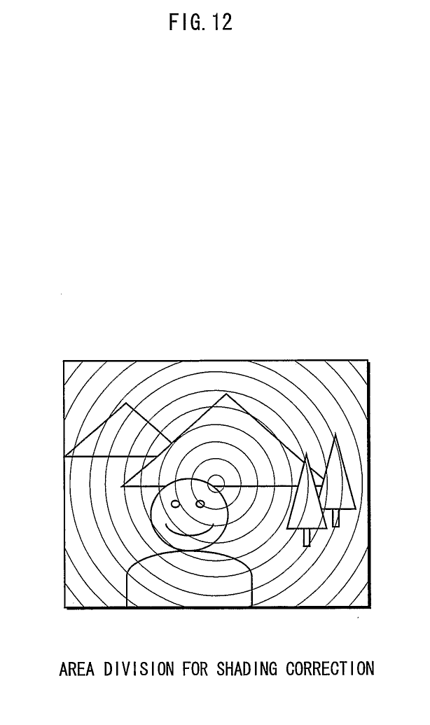

FIG. 12 is a diagram showing area division of a digital image relating to the present embodiment. As shown in FIG. 12, the digital image is divided into areas by concentric circles whose center coincides with the center of the digital image. By doing so, the digital image is divided into areas so that incident angles of each area are within a predetermined range. This helps decrease the number of areas, and so is instrumental in simplifying the operations and downsizing the circuit dimension.

### <4> FOURTH EMBODIMENT

Next, the fourth embodiment of the present invention is described. An electronic still camera relating to the present embodiment, too, is substantially the same in structure as the electronic still camera relating to the first embodiment, except for operations performed by the shading correction circuit. Specifically, in the first embodiment, the shading correction is performed using a digital image signal and correction data, whereas in the present embodiment, the shading correction is performed by replacing the digital image signal with replacement data. The following description mainly focuses on this difference.

(1) Structure of Shading Correction Circuit

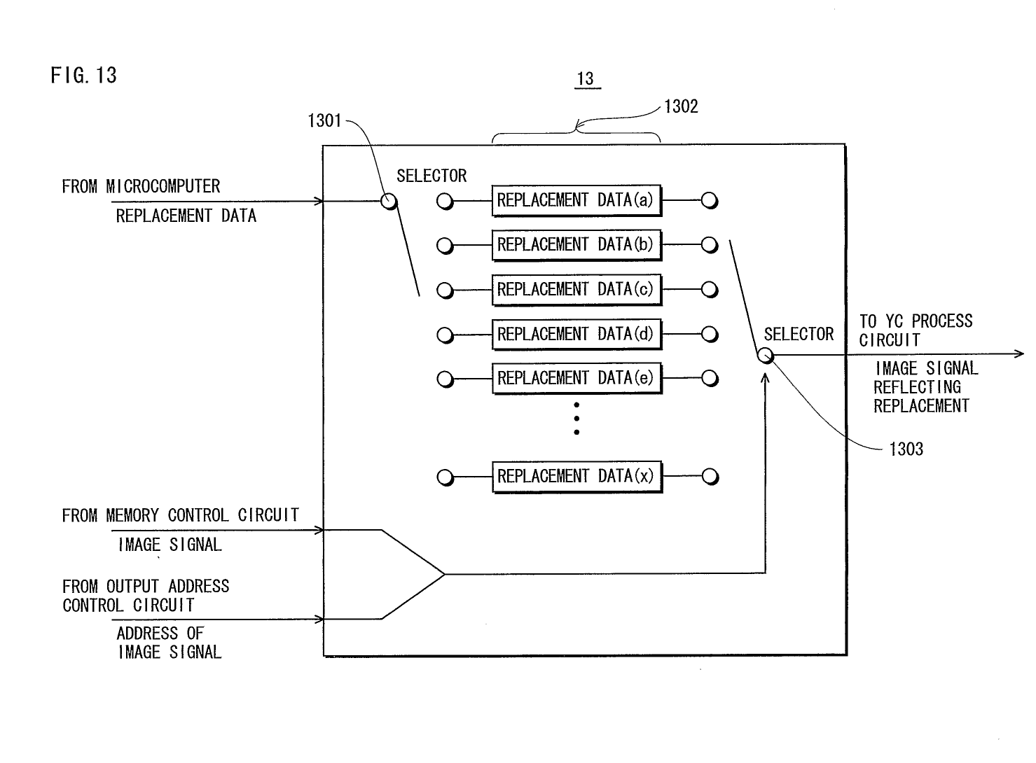

FIG. 13 is a block diagram showing a functional structure of a shading correction circuit relating to the present embodiment. As shown in FIG. 13, the shading correction circuit 13 includes a selector 1301, a selector 1303, and a replacement data storage unit 1302. The shading correction circuit 13 receives (A) a digital image signal from the memory control circuit, (B) an address of a digital image signal from the output address control circuit, and (C) replacement data from the microcomputer.

The replacement data storage unit 1302 has a plurality of storage areas from “a” to “x”, and is for storing therein replacement data used for the shading correction. The selector 1301 selects a storage area of the replacement data storage unit 1302, to which the replacement data received from the microcomputer is to be stored. The selector 1303 selects a storage area of the replacement data storage unit 1302, in accordance with the image signal and its address. By doing so, the replacement data having been stored in the selected storage area is sent to the YC processing circuit.

For example, the microcomputer may prepare in advance a plurality of sets of replacement data, and make the replacement data storage unit 1302 store a set of replacement data that a user of the electronic still camera selects. Such updating of replacement data is preferable at the activation of the electronic still camera, or in the case where there is remarkable improvement in the lens characteristic of the optical lens, for example.

By adopting such a structure stated above, operational errors ascribable to addition and multiplication are avoided, and so a more accurate shading correction is provided. In addition, since update of replacement data is performed freely, it becomes possible to deal with changes in shading ascribable to exchange of optical systems or the like, more flexibly.

(2) Modification Example

The above description deals with a case where the replacement data storage unit 1302 stores replacement data for each address of digital image signal. However, it is needless to say that the present invention is not limited to such a structure. The following structure is also possible for example. Only replacement data for representative addresses is prepared. For each address different from the representative addresses, its replacement data is generated using replacement data for representative addresses in the vicinity of the address.

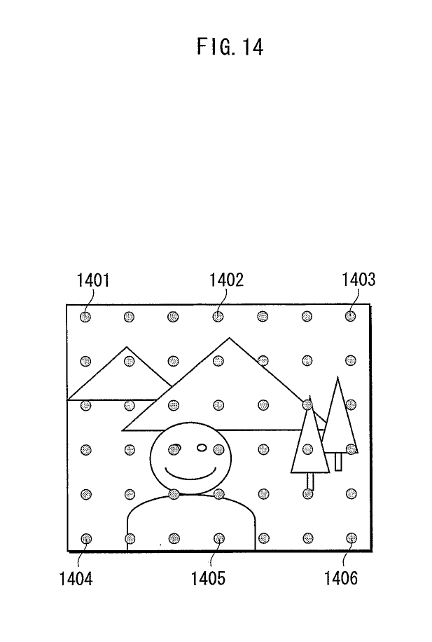

FIG. 14 is a diagram showing a selection example of representative addresses in a digital image. As shown in FIG. 14, dots 1401-1406, in a lattice pattern, correspond to representative addresses. By doing so, it becomes possible to reduce the storage capacity of the replacement data storage unit 1302 which helps reduce the cost of an electronic still camera.

In the above descriptions, it is stated as being possible to update the contents stored in the replacement data storage unit 1302. However, it is alternatively possible to use a ROM (read only memory) as the replacement data storage unit 1302. In this case, there is a disadvantage that update of the contents stored in the replacement data storage unit 1302 becomes impossible. However, it becomes possible to reduce component cost, thereby enabling provision of an electronic still camera at a reasonable price.

### <5> FIFTH EMBODIMENT

Next, the fifth embodiment of the present invention is described. An electronic still camera relating to the present embodiment is substantially the same in structure as the electronic still camera relating to the first embodiment, except that the present embodiment is able to change a digital signal operation according to each color filter characteristic. The following description mainly focuses on this difference.

(1) Structure of Electronic Still Camera

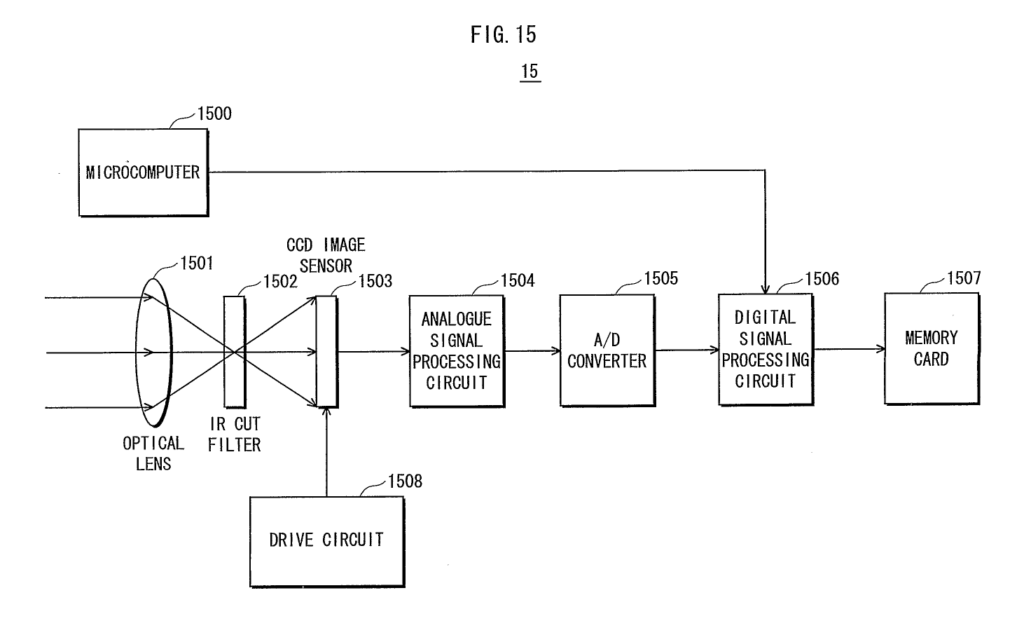

FIG. 15 is a block diagram showing a functional structure of an electronic still camera relating to the present embodiment. As shown in FIG. 15, the electronic still camera 15 includes a microcomputer 1500, an optical lens 1501, an IR cut filter 1502, an image sensor 1503, an analogue signal processing circuit 1504, an A/D converter 1505, a digital signal processing circuit 1506, a memory card 1507, and a drive circuit 1508. The microcomputer 1500 inputs, to the digital signal processing circuit 1506, a characteristic parameter of a color filter of the image sensor 1503.

(2) Structure of Digital Signal Processing Circuit 1506

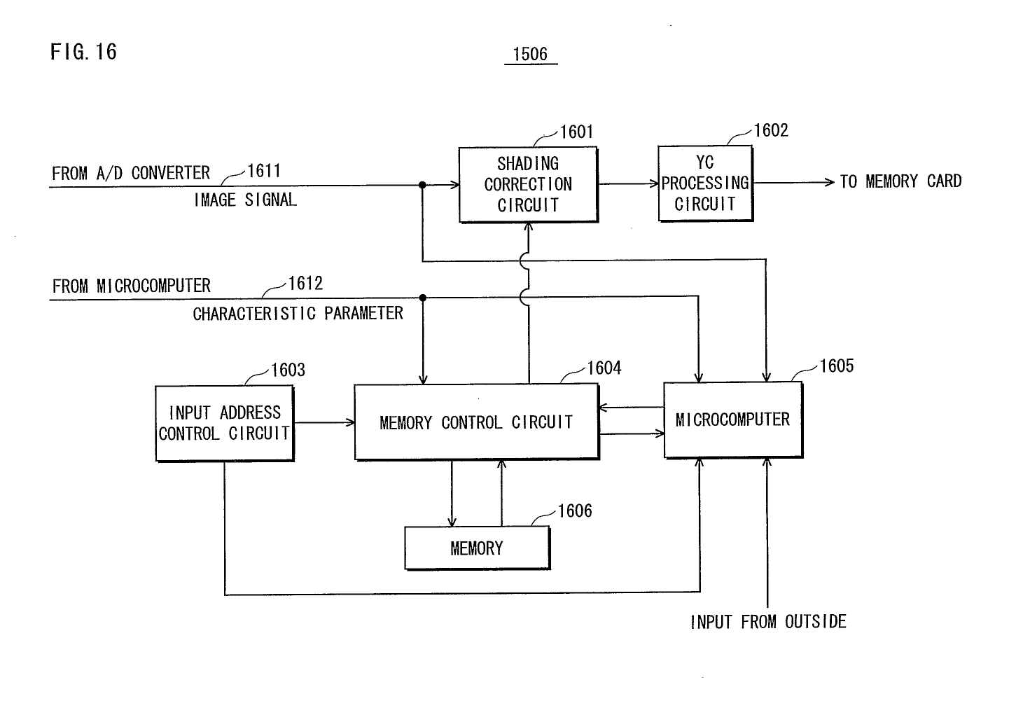

FIG. 16 is a block diagram showing a functional structure of the digital signal processing circuit 1506. As shown in FIG. 16, the digital signal processing circuit 1506 includes a shading correction circuit 1601, a YC processing circuit 1602, an input address control circuit 1603, a memory control circuit 1604, a microcomputer 1605, and a memory 1606.

The memory 1606 stores correction data for each address of digital image signal. The shading correction circuit 1601 specifies an address of a digital image signal, and reads correction data from the memory 1606 via the memory control circuit 1604, for performing shading correction.

The microcomputer 1605, upon reception of a command from outside to update correction data, specifies the address of a digital image signal, and reads the correction data from the memory 1606. The microcomputer 1605 updates the correction data using the characteristic parameter of the color filters received from the microcomputer 1500, and writes the updated correction data to the memory 1606.

(3) Modification Example

In the above description, the memory 1606 stores correction data for each address of digital image signal. However, it is needless to say that the present invention is not limited to such a structure. It is also possible that the fifth embodiment is given the similar structure to those explained in the fourth embodiment. Namely, only correction data for representative addresses is stored, and for each address different from the representative addresses, its correction data is interpolated with use of the correction data for the representative addresses.

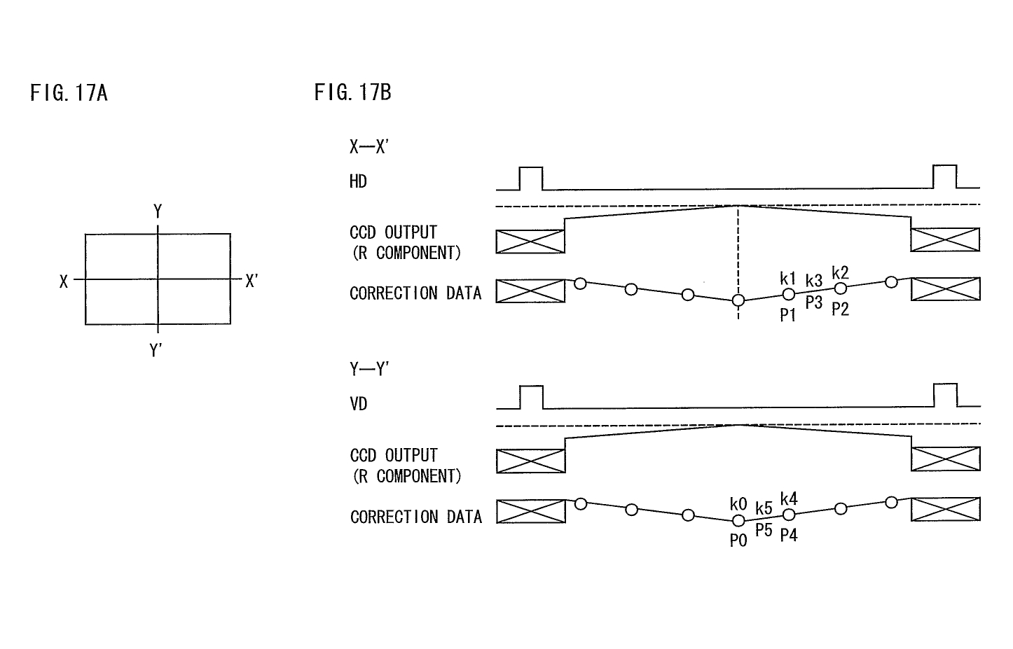

The following details one example of interpolation, in which correction data is prepared for a plurality of representative addresses differing from each other in distance from the center of the digital image. FIGS. 17A and 17B relate to graphs showing how the shading characteristic of a digital image signal and correction data change, for each position in a digital image. FIG. 17A is a diagram showing a digital image. In FIG. 17A, the straight line X-X′ traverses the digital image in the horizontal direction, and the straight line Y-Y′ traverses the digital image in the vertical direction.

FIG. 17B shows shading characteristics and correction data of the digital image signal, respectively at the straight line X-X′ and at the straight line Y-Y′. As for the shading characteristics, only the red (R) component is shown. In FIG. 17B, the dots respectively represent correction data for a representative address.

As shown in FIG. 17B, when the shading characteristics for both of the horizontal/vertical directions are such that they are the highest in the center of a digital image, and get lowered towards the edges, the correction data will be conversely the lowest in the center of the digital image, and gets higher towards the edges.

For example, correction data k3 at an address p3 is calculated using correction data k1 and k2 for representative addresses p1 and p2 as follows:

K3={(k2−k1)×Δ1/Δ0}+k1

Here, AO represents a distance between the address p1 and the address p2, and Δ1 represents a distance between the address p1 and the address p3. Alternatively, the correction data k3 may be calculated as follows:

K3={(k2−k1)×(Δ1/Δ0)²}+k1

It depends on the shading characteristic which one of the calculation methods should be adopted, or other calculation methods should be adopted. It is possible to use other functions than a linear function and a quadratic function for interpolation. It is also possible to use a combination of a plurality of functions for interpolation. The above description only discusses an interpolation method for correction data in the horizontal direction of a digital image. However interpolation may be similarly performed in the vertical direction.

In the center of a digital image of FIG. 17B, it is not possible to obtain proper correction data if it is interpolated using correction data using the representative addresses in the vicinity. It is preferable to recognize such an address as a representative address, and to store corresponding correction data for it in advance. In addition, the correction data that the microcomputer 1605 has interpolated can be either stored in the memory 1606 or input in the shading correction circuit 1601.

### <6> SIXTH EMBODIMENT

Next, the sixth embodiment of the present invention is described. The electronic still camera relating to the present embodiment is substantially the same in structure as the electronic still camera relating to the first embodiment, except for operations performed by the digital signal processing circuit. Specifically, in the above embodiments, color differences are corrected by a shading correction. However the present embodiment attempts to resolve color differences by deleting the portion of the digital image where the color difference is noticeable. The following description mainly focuses on this difference.

(1) Structure of Digital Signal Processing Circuit

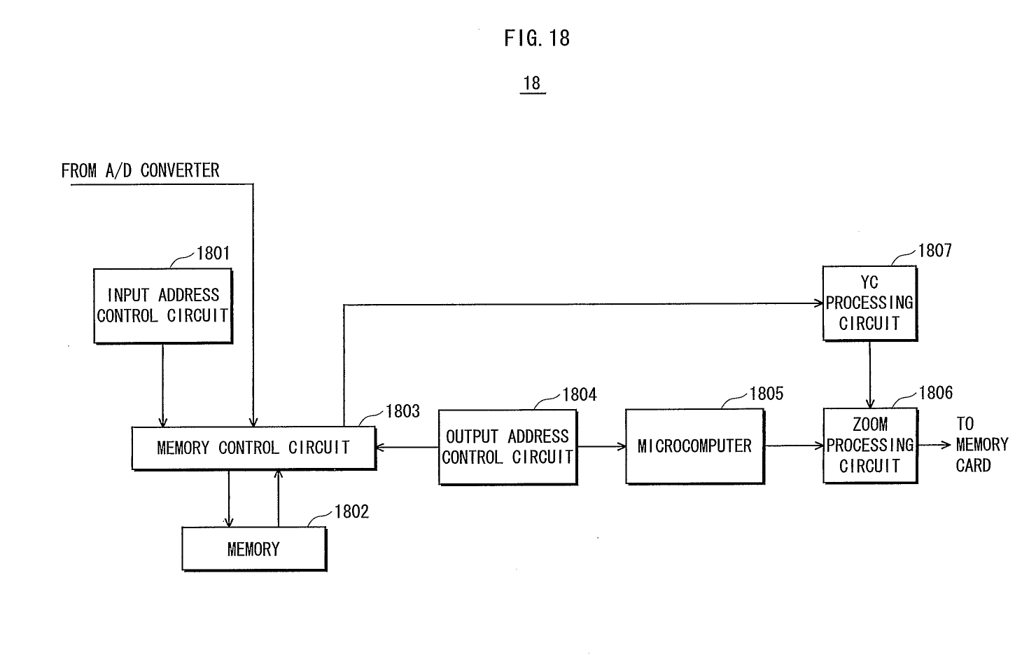

FIG. 18 is a block diagram showing a functional structure of a digital signal processing circuit relating to the present embodiment. As shown in FIG. 18, the digital signal processing circuit 18 includes an input address control circuit 1801, a memory 1802, a memory control circuit 1803, an output address control circuit 1804, a microcomputer 1805, a zoom processing circuit 1806, and a YC processing circuit 1807. The zoom processing circuit 1806 performs trimming and pixel interpolation to an image signal output by the YC processing circuit 1807, in accordance with an instruction given by the microcomputer 1805.

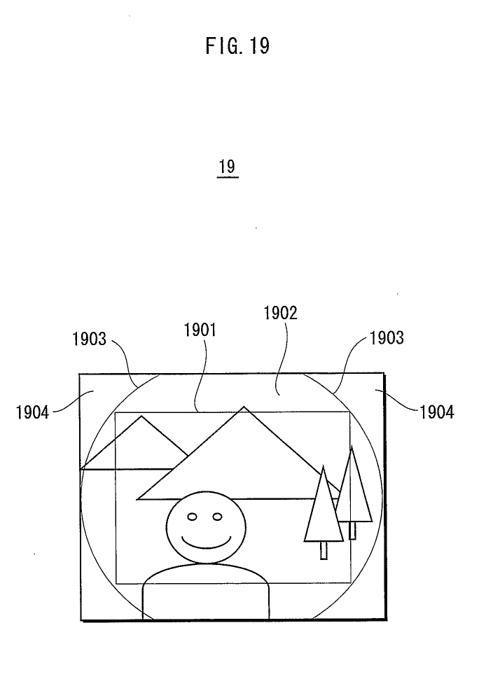

FIG. 19 is a diagram showing an example of a digital image that the digital signal processing circuit 18 processes. In FIG. 19, a curve 1903 represents a boundary between an area 1904 in which the color difference is noticeable and an area 1902 in which the color difference is not noticeable. The position of the curve 1903 is defined by the shading characteristics. The microcomputer 1805 decides an area 1901 having a rectangular shape that fits in the area 1902 and that has a predetermined aspect ratio. The microcomputer 1805 then instructs the zoom processing circuit 1806 to cut the rectangular area.

If the rectangular area 1901 is output as a digital image as it is, the number of pixels is not sufficient. In view of this, the zoom processing circuit 1806 interpolates pixels, thereby zooming the rectangular area 1901 into the same size as that of the digital image 19. Thus obtained digital image is output to a memory card.

As a result, a video signal that does not cause color difference is obtained.

Note that trimming may be optionally performed after a shading correction is performed as stated above.

### <7> MODIFICATION EXAMPLES

So far, the present invention has been described by way of the embodiments. Needless to say, however, the present invention should not be limited to the specific embodiments described above. For example, the following modification examples are possible.

(1) In the first embodiment stated above, the thickness of a spacer layer, sandwiched between λ/4 multi-layer films, is adjusted for adjusting the wavelength of light transmitted through the color filters. However, it is needless to say that the present invention should not be limited to such a structure and the following modification is possible, for example.

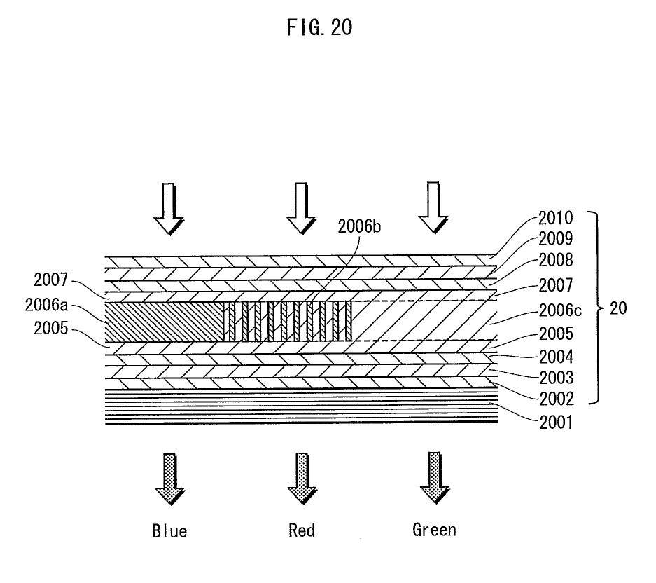

FIG. 20 is a sectional diagram showing the structure of color filters relating to the present modification example. As shown in FIG. 20, the color filters 20 are formed on an insulation layer 2001 by stacking a titanium oxide layer 2002, a silicon oxide layer 2003, a titanium oxide layer 2004, a silicon oxide layer 2005, spacer layers 2006a-2006c, a silicon oxide layer 2007, a titanium oxide layer 2008, a silicon oxide layer 2009, and a titanium oxide layer 2010, in the stated order.

The spacer layer 2006a is made of titanium oxide. The spacer layer 2006a, and two λ/4 multi-layer films sandwiching the spacer layer 2006 constitute a color filter for transmitting blue light. The spacer layer 2006b is made by alternately arranging titanium oxide portions and silicon oxide portions, in the direction along a main surface of the color filters 20. The spacer layer 2006b transmits red light, in collaboration with the λ/4 multi-layer films. The spacer layer 2006c is made of silicon oxide, and transmits green light.

In the plan view of the spacer layer 2006b, an area ratio of the titanium oxide portions and the silicon oxide portions is 1:4. Accordingly, a refractive index of the spacer layer 2006b with respect to red light is calculated as follows:

((refractive index of silicon oxide)×⅘)+((refractive index of titanium oxide)×⅕)

By doing so, it is possible to reduce processes required for manufacturing color filters, thereby helping reducing the term of work required therefor and enabling the manufacturing cost to be lowered.

(2) In the first embodiment stated above, the light shielding films 304 are provided in the insulation layer 303. Needless to say, however, the present invention is not limited to this structure, and the following structure is possible, for example.

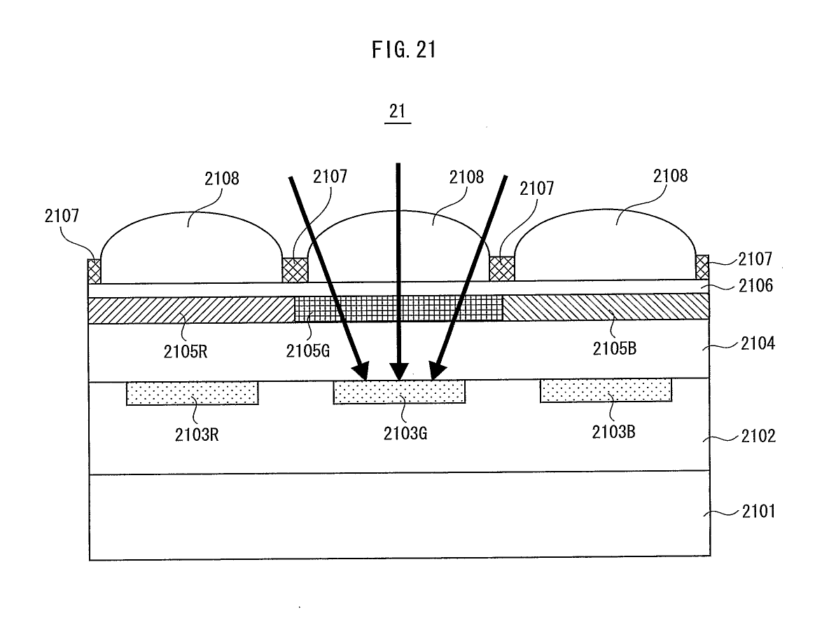

FIG. 21 is a sectional diagram showing a part of the structure of an image sensor relating to the present modification example. As shown in FIG. 21, the image sensor 21 includes an n-type semiconductor layer 2101, a p-type semiconductor layer 2102, light receiving devices 2103R-2103B, insulation layers 2104 and 2106, color filters 2105R-2105B, a light shielding film 2107, and microlenses 2108.

The p-type semiconductor layer 2102 is formed on the n-type semiconductor layer 2101. The light receiving devices (2103R and so on) are respectively a photodiode (photoelectric transducer) formed by ion-implanting an n-type impurity to the p-type semiconductor layer 2102. The light receiving devices (2103R and so on) are in contact with the insulation layer 2104 that transmits light. The light receiving devices (2103R and so on) are separated from each other by respective portions of the p-type semiconductor layer 2102. The color filters 2105R-2105B are formed on the insulation film 2104.

The color filters 2105R-2105B are filters that exclusively transmit primary colored light of R, G, and B, respectively, and are made of an inorganic material. The color filters are arranged in a Bayer pattern or in a complementary color pattern.

The insulation layer 2106, which transmits light, is formed on the color filters 2105R-2105B. On the insulation layer 2106, the microlenses 2108 are provided so that one microlens corresponds to one light receiving device. The light shielding film 2107 divides the microlenses 2108 from each other. The light shielding film 2107 reflects light incident to them. Light incident upon each of the microlenses 2108, on the other hand, will be focused on a corresponding one of the light receiving devices (e.g. light receiving device 2103R).

By doing so, it becomes possible to shorten the distance between the color filters and the color receiving devices, and so it becomes difficult for slanting rays of light to reach the light receiving devices. For example, when the light receiving devices (2103R and so on) have a width of 3 μm, mixed color of light will be reduced approximately 80% from the conventional cases. In addition, the image sensor 21 is only manufacturable by a semiconductor process, which is easy and does not incur a large amount of cost.

(3) In the present description, “λ/4 multi-layer film” stated in the embodiments is to be interpreted as follows.

First, a multi-layer film formed by alternately stacking a low refractive-index layer and a high refractive-index layer, both exhibiting high transparency with respect to visible light, is described. Light incident upon the multi-layer film in the slanting direction with respect to the stacking direction of the multi-layers is partially transmitted through each layer, and partially reflected off each interface in the multi-layers, because of different refractive indices between adjacent layers. The summation of light reflected from each interface is considered as light reflected from the entire multi-layer film structure.

When different interfaces reflect light in the same phase, a high reflection characteristic is generated. On the contrary, when different interfaces reflect light in opposite phases to each other, a low reflection characteristic is generated. Therefore, if attempting to use a multi-layer film as a high-reflection coating film, it is necessary to design the multi-layer film so that all the interfaces therein reflect light of the same phase.

On condition that each layer of such a multi-layer film has the same optical thickness, light reflected from the multi-layer film will fall within in a predetermined band centered on the wavelength “λ” having a value of four times the optical thickness. Hereinafter, the wavelength “λ” is called “center wavelength”, and the predetermined band is called “reflection band”. Such a-multi-layer film is called “λ/4 multi-layer film”.

For the λ/4 multi-layer film, it is possible to arbitrarily set its reflection band by selection of the optical thickness for each layer. It is also possible to enlarge the band width of the reflection band by enlarging the difference in refractive indices between the high refractive index layer and the low refractive index layer, or by increasing the number of pairs of low-refractive index layer and high-refractive index layer.

(4) The above-stated embodiments adopt color filters having a multi-layer film structure. Needless to say, however, the present invention is not limited to this structure, and the following structure is also possible, for example.

(4-1) Structure of Image Sensor

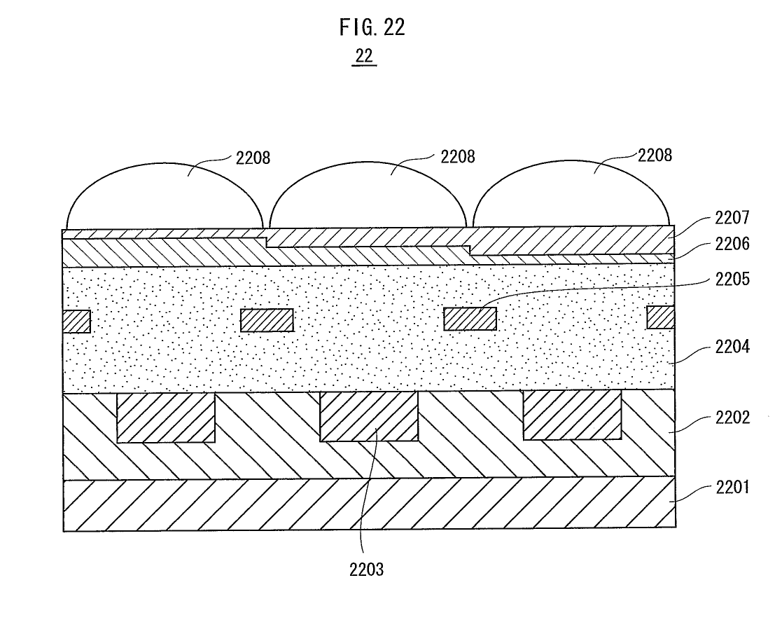

FIG. 22 is a sectional diagram showing a part of the structure of an image sensor relating to the present modification example. As shown in FIG. 22, in an image sensor 22, a p-type semiconductor layer 2202, an insulation film 2204, color filters 2206, a flattening layer 2207, and microlenses 2208, are stacked on an n-type semiconductor layer 2201 in the stated order.

Photoelectric transducers 2203 are formed in the p-type semiconductor layer 2202 to be in contact with the insulation film 2204, by ion-implanting an n-type impurity to the p-type semiconductor layer 2202.

The insulation film 2204 is an insulation film that transmits light. Light shielding films 2205 are provided in the insulation film 2204. The light shielding films 2205 function to make sure only light transmitted through a color filter 2206 is incident to a corresponding photoelectric transducer 2203.

The color filters 2206 are in a single-layer structure made of amorphous silicon. The thickness of the color filters 2206 differs among the following three positions: position opposing the photoelectric transducer 2203 for receiving red light (hereinafter “red region”); position opposing the photoelectric transducer 2203 for receiving green light (hereinafter “green region”); and position opposing the photoelectric transducer 2203 for receiving blue light (hereinafter “blue region”).

The flattening layer 2207 is made of silicon oxide, and is for flattening the upper surface of the device, to make a distance between the photoelectric transducers 2203 and the microlenses 2208 constant.

The microlenses 2208 are provided on the flattening layer 2207 in positions corresponding to the photoelectric transducers 2203. The microlenses 2208 focus incident light on the photoelectric transducers 2203.

(4-2) Film Thickness of Color Filters 2206

Next, the film thickness of the color filters 2206 is described.

The film thickness of the color filters 2206 is determined in accordance with the wavelength λ of light to be transmitted in each region (e.g. wavelength to be transmitted at largest transmission ratio in each region, which is hereinafter called “peak wavelength”). The following equation is used to calculate the film thickness of the color filters 2206.

nd=λ/2 (1)

Here, “n” represents a refractive index relating to light having a wavelength λ in each region, and “d” represents a film thickness for each region. Generally, the product of “n” and “d” is referred to as an optical thickness.

The refractive indices “n” of polysilicon relating to light having peak wavelengths λ of 650 nm, 530 nm, and 470 nm are 4.5, 4.75, and 5.0, respectively. In view of this, in the present modification example, the film thickness of the color filters 2206 is defined as follows: 70 nm in the red region; 55 nm in the green region; and 40 nm in the blue region.

Note that the wavelength of visible light falls within the range of 300 nm to 800 nm. Therefore, the optical thickness of the color filters 2206 should fall within the range of 150 nm to 400 nm, inclusive. In case where the infrared wavelength region is to be taken into account, it becomes accordingly necessary to raise the upper limit for the film thickness of the color filters 2206.

(4-3) Transmission Characteristic of Color Filters 2206

Next, the transmission characteristic of the color filters 2206 is described.

Generally speaking, when light having wavelength of twice the optical thickness transmits through a light transmission layer, its transmittance is enhanced by an interference effect. More specifically, when light travels from inside to outside of a light transmission layer, part of the light reflects from the interface of the light transmission layer. The interference between transmitted light and reflected light enhances the transmittance.

When the light transmission layer is made of an absorption material, light having shorter wavelength will be absorbed more due to the chromatic dispersion of the extinction coefficient. There is a certain value of wavelength above which the absorption rate reaches almost 0. This certain value of wavelength is called “cut-off wavelength”.

Since amorphous silicon that constitutes the color filters 2206 is an absorption material, light traveling through the color filters 2206 undergoes both of interference and absorption. In particular, because of having a large refractive index, amorphous silicon has a large reflection rate and a large interference effect. In addition, because of having a large absorption coefficient, amorphous silicon has a high absorption ratio with respect to short wavelength. According to these characteristics of amorphous silicon, the color filters 2206 are endowed with a high color separation function.

Note that what is meant by “absorption material” in the present description is a material having a wavelength at which an extinction coefficient of 0.1 or more results, within the wavelength range of 400 nm to 700 nm. Examples of the absorption material include polysilicon, single-crystal silicon, titanium oxide, tantalum oxide, and niobium oxide.

The following relation holds for the absorption coefficient α, the extinction coefficient k, and the wavelength λ.

K=α×λ/4π

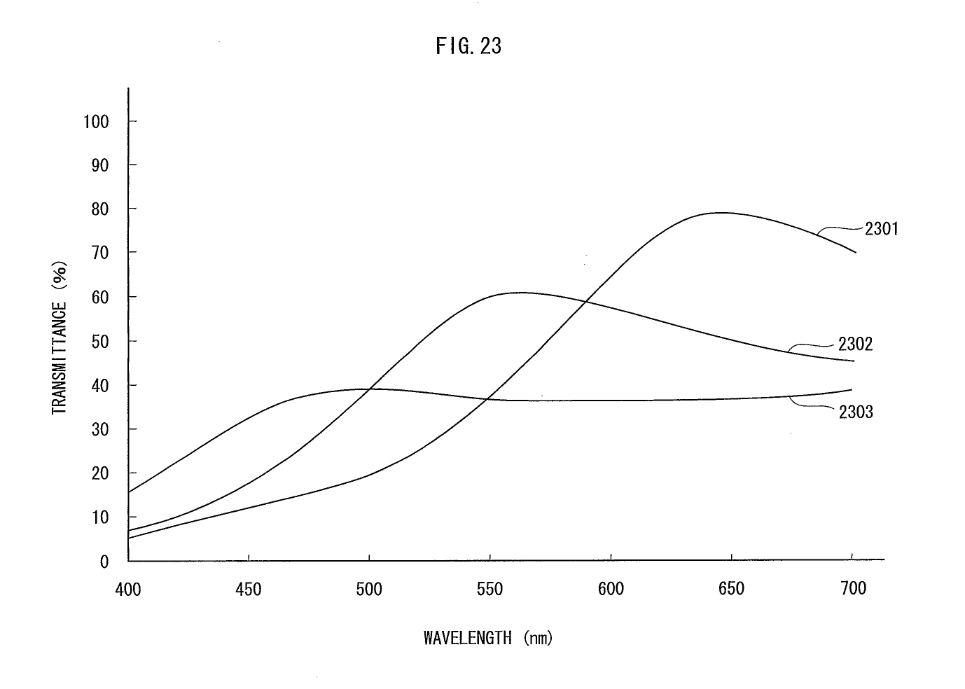

FIG. 23 is a graph showing the transmission characteristic of the color filters 2206 in each region. In FIG. 23, the horizontal axis represents a wavelength of incident light upon the color filters 2206, and the vertical axis represents a transmittance for each wavelength. The graphs 2301-2303 represent transmission characteristics in the red region, the green region, and the blue region, respectively.

As FIG. 23 shows, the transmission characteristic of the color filters 2206 is such that as the film thickness increases, the peak wavelength becomes long. More specifically, the following is seen from FIG. 23. In the red region where the film thickness is the greatest, the peak wavelength is the longest (graph 2301). In the green region where the film thickness is the second greatest, the peak wavelength is also the second longest (graph 2302). Finally, in the blue region where the film thickness is the smallest, the peak wavelength is accordingly the shortest (graph 2303).

From FIG. 23, it is also observed that as the wavelength becomes short, the transmittance becomes accordingly low, within each of the regions. This phenomenon is attributable to the absorption effect of the amorphous silicon as stated above.

(4-4) Advantages of Color Filters 2206

The color filters 2206 have the following advantages, in addition to the high color separation function stated above.

That is, when color filters use organic pigments, it is necessary to manage different materials (e.g. pigment, dye, and the like), for each of the wavelengths to be transmitted. Compared to this, the color filters 2206 are made of a single organic material, and so do not incur such a material management.

In addition, when color filters use organic pigments, it is necessary to perform a color filter manufacturing process that deals with acrylic resin. On the other hand, the color filters 2206 are manufacturable by a semiconductor process, just as the other components of the image sensor 22 are. Therefore, it is possible to reduce processes required for manufacturing the image sensor 22, thereby helping reduce the term of work required and enabling the manufacturing cost to be lowered. In addition, the same manufacturing facilities as used for the other components of the image sensor 22 are usable for the color filters 2206.

Furthermore, the color filters 2206 are extremely thin on the whole, and even the thickest region thereof has a film thickness of only 70 nm. Therefore, the color filters 2206 are very effective to counter the slanting-light problem that light transmitted through a certain region of the color filters 2206 to be incident upon a photoelectric transducer 2003 that is not corresponded with the region, to generate a mixed color of light.

The color filters 2206 are formed after the light shielding films 2205 have been formed. Amorphous silicon which is a material of the color filters 2206 can be coated with a low temperature. Therefore, if a material with a low melting point, such as aluminum (Al), is used for the light shielding films 2205, it is possible to restrain the stress to be exercised on the light shielding films 2205 ascribable to forming of the color filters 2206. Accordingly, the light shielding films 2205 will be protected from adverse effect due to the stress.

(4-5) Modification Example

As stated above, the color separation function of the color filters 2206 changes in accordance with the change in the film thickness. This means that the transmission characteristics also change if there is a change in optical path length of the light transmitted through the color filters 2206, due to the change in the incident angle of the light incident upon the color filters 2206.

When the incident angle of the light incident upon the color filters 2206 changes uniformly on the whole, signal processing is instrumental in eliminating the change of transmission characteristics. In addition, when the incident angle changes for each pixel positions, signal processing is also effective for eliminating the change. In this way, if the color filters 2206 of this modification example are used in conjunction with signal processing, more excellent color reproducibility is realized.

(5) All the above-described embodiments have dealt with the color filters for separating three primary colors of red, green, and blue. Needless to say, however, the present invention is not limited to this structure, and a color filter for separating other colors may be alternatively used. For example, a color filter for separating three primary colors of cyan, magenta, and yellow may be used.

### INDUSTRIAL APPLICABILITY

An image input apparatus and an image input method, which relate to the present invention, are of value as an apparatus and a method for resolving color differences that occur in a digital image due to the characteristics of a color filter.

1. An image input apparatus comprising a solid-state imaging device for capturing an image of a subject, and a signal processing unit for processing an image signal that the solid-state imaging device outputs, wherein
the solid-state imaging device includes:
a plurality of filter units made of an inorganic material, each filter unit being operable to transmit a corresponding one of color components of light; and
a plurality of light receiving units arranged two-dimensionally in a semiconductor substrate, each light receiving unit being operable to receive one of the color components of light transmitted through a corresponding one of the filter units, and
the signal processing unit corrects the image signal in accordance with the color components and positions in the captured image.

2. The image input apparatus according to claim 1, wherein
the filter units have a multi-layer film structure.

3. The image input apparatus of claim 2, wherein
each of the filter units includes: two λ/4 multi-layer films, each of which is made of a plurality of dielectric layers; and an insulation layer sandwiched between the λ/4 multi-layer films, the insulation layer having an optical thickness different from λ/4.

4. The image input apparatus of claim 3, wherein
the optical thickness of the insulation layer differs according to color components of light to be received by the corresponding light receiving units.

5. The image input apparatus of claim 3, wherein
each of the λ/4 multi-layer films is made of a high refractive-index material and a low refractive-index material, the insulation layer contains first portions made of the high refractive-index material and second portions made of the low refractive-index material, the first and second portions being arranged alternately in a direction along a main surface of the filter units, and the insulation layer transmits light of a wavelength that is in accordance with an area ratio between the first portions and the second portions in a plan view.

6. The image input apparatus of claim 1, wherein
the solid-state imaging device includes a light shielding unit, the light shielding unit being operable to shield incident light and being positioned in an opposite side of the light receiving units with respect to the filter unit, and
the light shielding unit is provided with openings in positions corresponding to the light receiving units respectively, in order for the incident light to pass through.

7. The image input apparatus of claim 1, wherein
the signal processing unit divides the captured image into two or more areas, and corrects the image signal in accordance with the color components and the areas.

8. The image input apparatus of claim 1, wherein
the signal processing unit divides the captured image into two or more areas by figures having shapes similar to each other but different in size from each other, the figures sharing a same center, and the signal processing unit corrects the image signal in accordance with the color components and the areas.

9. The image input apparatus of claim 8, wherein
where an optical lens forms a subject image to be captured by the solid-state imaging device, and a diaphragm restricts light to be incident upon the optical lens,
the figures are substantially similar in shape to an aperture of the diaphragm.

10. The image input apparatus of claim 8, wherein
the shape of the figures is substantially circular.

11. The image input apparatus of claim 1, wherein
the signal processing unit corrects the image signal by multiplying a level of the image signal by a coefficient that is determined in accordance with the color components and the positions in the captured image.

12. The image input apparatus of claim 1, wherein
the signal processing unit corrects the image signal by adding, to a level of the image signal, a constant that is determined in accordance with the color components and the positions in the captured image.

13. The image input apparatus of claim 1, wherein
the signal processing unit corrects the image signal by adding, to a level of the image signal, a constant that is determined in accordance with the color components and the positions in the captured image, and by multiplying a result of the addition by a coefficient that is determined in accordance with the color components and the positions in the captured image.

14. The image input apparatus of claim 1, comprising:
a storage unit storing correction data, wherein
the signal processing unit corrects the image signal using the correction data.

15. The image input apparatus of claim 14, wherein
the signal processing unit replaces a level of the image signal with the correction data, in accordance with the color components and the positions in the captured image.

16. The image input apparatus of claim 14, wherein
the storage unit has a nonvolatile memory to store the correction data.

17. The image input apparatus of claim 14, wherein
the storage unit has a volatile memory to store the correction data.

18. The image input apparatus of claim 17, comprising:
an update unit operable to update the correction data stored in the storage unit.

19. The image input apparatus of claim 1, comprising:
a storage unit storing first correction data for correcting the image signal for a part of the positions, wherein
the signal processing unit a) performs the correction for the part of the positions, by using the first correction data, and b) performs the correction for the other part of the positions, by using second correction data calculated from the first correction data.

20. The image input apparatus of claim 19, wherein
one piece of the second correction data is calculated from two pieces of the first correction data, using a linear function.

21. The image input apparatus of claim 19, wherein
one piece of the second correction data is calculated from two pieces of the first correction data, using a quadratic function.

22. An image input apparatus comprising a solid-state imaging device for capturing an image of a subject, and a signal processing unit for processing an image signal that the solid-state imaging device outputs, wherein
the solid-state imaging device includes:
a plurality of filter units made of an inorganic material, each filter unit being operable to transmit a corresponding one of color components of light; and
a plurality of light receiving units arranged two-dimensionally in a semiconductor substrate, each light receiving unit being operable to receive one of the color components of light transmitted through a corresponding one of the filter units, and
the signal processing unit generates an image using image signals corresponding to coordinates that fall within a predetermined distance from a center of the captured image.

23. The image input apparatus of claim 22, wherein
the signal processing unit, prior to generating the image, corrects the image signals in accordance with the color components and the positions in the captured image.

24. The image input apparatus of claim 1, wherein
the filter units are made of a single-layer film that has optical thicknesses respectively substantially equal to ½ of wavelengths corresponding to color components of light to be transmitted.
